(19) United States
(12) Patent Application Publication
(10) Pub. No.: US 2004/0035942 A1
(43) Pub. Date: Feb. 26, 2004

(54) Dynamic virtual magnetic stripe

(76) Inventor: Martin S. Silverman, Camarillo, CA (US)

Correspondence Address: Bruce A Jagger, Brunton & Jagger, PO Box 29000, Glendale, CA, 91209-9000, US

(21) Appl. No.: 10/433,018

(22) PCT Filed: Dec. 7, 2001
(86) PCT No.: PCT/US01/47130

(51) Int. Cl. G06K 19/06; G06K 7/08

(52) U.S. Cl. 235/493; 235/449

(57) ABSTRACT

The combination of a specially configured transaction card (10) and a magnetic pattern reader device (18) minimizes the power consumed by the operation of the smartcard format transaction (10). The transaction card (10) has a plurality of logically and electrically interconnected members, including at least one electromagnetic member with low magnetic permeability core element. The electromagnetic element generates a magnetic pattern. A logic processor member (16) controls the generation of the magnetic pattern. A self-contained energy source (14) powers the system. The magnetic pattern reader device includes a magnetically permeable element that has a higher magnetic permeability than that of the magnetic pattern generator. The magnetic pattern reader device is readably associated with the magnetic pattern generator so as to directly read the magnetic pattern.

### RELATED APPLICATIONS

This is a continuation-in-part of U.S. Provisional Application No. 60/251,846 filed Dec. 8, 2000, which entire provisional application is hereby incorporated herein by reference.

### BACKGROUND OF THE INVENTION

1. Field of the Invention

The invention relates in general to the presentation of recorded information, and, in particular, to the presentation of recorded information by means of a power efficient dynamic virtual magnetic stripe.

2. Description of the Prior Art

It is well recognized that information may be recorded by magnetic means on magnetic stripes, and that suitable devices may read the resulting recorded information. Most credit or other transaction cards, for example, include a magnetic stripe. A recording device typically encodes information in a more or less permanent magnetic pattern on the transaction card. The magnetic media of which the magnetic stripe is composed is magnetized in specific spatial patterns. These magnetic spatial patterns are composed of magnetic flux reversals, and are termed magnetic transitions. The magnetically encoded information in the magnetic stripe is recognized, read and interpreted by magnetic stripe reading devices. Typically, this is accomplished by swiping the card through a reader. Card readers are typically in the form of transaction terminals located, for example, at a merchant's place of business. The encoded information is generally intended to be static, that is, the information represented by the magnetic spatial patterns on the magnetic stripe generally do not change even though the card may be read hundreds of times.

Cards that provide magnetic encoded information for financial, security, identification, and the like purposes are generically described as “transaction cards”. Typical transaction cards currently bear magnetically encoded information in a fixed format. This limits the flexibility and usefulness of current transaction cards. It is well recognized that the use of so called smartcards with a magnetic encoding mechanism as transaction cards, would greatly improve the flexibility, capacity, security, utility and other benefits of transaction cards. Such self contained smartcard based transaction cards would include embedded logic processors, including microprocessors, ROM, RAM, and other well known electronic components. One of the major problems with using smartcard transaction cards is that there is no fully satisfactory self contained power source to provide electrical power to the electrical components over the expected life of a transaction card. In part this is due to the limitations on the capacity of the available power sources, and in part it is due to the power supply demands that current smartcard technology places on any power supply. According to the present invention, the demands on the power supply are minimized so that it is practical to use smartcard technology in transaction cards.

Various expedients have been proposed to substitute for, change or add to the conventional magnetic stripe. Such proposed expedients include, for example, Francini et al. U.S. Pat. No. 4,701,601 ('601); Hodama U.S. Pat. No. 4,786,791 ('791); Burkhardt U.S. Pat. No. 4,791,283 ('283); Goldberg U.S. Pat. No. 5,434,398 ('398); Cooper U.S. Pat. No. 5,834,747 ('747); and Krause U.S. Pat. No. 6,089,451 ('451).

The Francini '601 patent teaches the use of an electromagnetic coil transducer as a magnetic stripe emulator. The '601 patent describes the magnetic flux that is associated with the transducer as “varying”, but magnetic flux reversal is not disclosed or suggested. The electromagnetic coil transducer is disclosed to be grounded. A grounded electromagnetic coil is generally not capable of generating magnetic flux reversal, because the polarity can not be reversed unless negative and positive voltage relative to ground is supplied sequentially to the coil. The teachings of the '601 patent are to the contrary. The '601 patent does not disclose or suggest the generation of magnetic flux reversal. Most magnetic stripe readers require magnetic flux reversals for their operation, and would require modification to be used with the device taught by the '601 patent. There is no suggestion in the '601 patent that there would be any reason to employ a low permeability core in the transducer or even one that is less permeable than the core in the magnetic reader head. The teaching of the '601 patent is that, to conserve power, the transducer should only generate one 30 to 100 millisecond long burst of data each second. Following this teaching, for power conservation reasons, there should be almost a full second between signals. This would require the transducer to be held stationary to the reader, because most transaction cards are swiped through the typical reader in less than one second. This would require retraining the legions of retail clerks worldwide who swipe transaction cards every day. The '601 patent does not teach or suggest a device that could be directly substituted for the conventional magnetic stripe card.

The Hodama '791 patent purports to describe a magnetic stripe simulator, which is described as a card coil. The disclosed card coil is composed of wire windings on a high permeability core. The '791 patent teaches that it is necessary to use a high permeability core in the card coil. This follows the conventional wisdom that magnetic flux output should be maximized. The use of core materials that exhibit high magnetic permeability increases the flux density. Where only a small amount of power is available, as from a very small battery, the conventional wisdom suggests using a core with the highest magnetic permeability possible so the signal will be strong enough for the magnetic reader to detect. The use of low permeability core materials is counterintuitive. The '791 patent, considered in its entirety, teaches away from using a card coil with a core that has low permeability, or even less permeability than that of an associated card reader. The core materials from which the cores in typical general purpose reader heads are made have magnetic permeabilities of at least approximately 10,000. As is well known, permeability values vary with, inter alia, the frequency, so the values for permability are approximate and taken in context with the application.

The Burkhardt '283 patent purports to disclose an elongated magnetic field generator in the form of a loop inductor for emulating a prerecorded magnetic stripe. The core is highly permeable and a diamagnetic material is provided between the elongated pole pieces of the magnetic circuit for the stated purpose of increasing the field strength outside of the card. There is no suggestion that just the use of a low permeability core in a linear inductive element could provide sufficient flux to be detected by a magnetic reader. The flux lines in this device are apparently oriented so they extend perpendicular instead of parallel to the longitudinal axis of the emulated stripe. The operation of the disclosed device requires the use of a means that senses the position and rate of movement of the card relative to the reader. This in turn requires the availability of an external power supply in the reader. The reader must be modified to provide power to the card. This is not a direct replacement for the conventional magnetic stripe. It is not clear whether the reader provides all of the necessary power for the operation of the card. With the poles extended for the length of the card away from the coils, the power requirement to generate a detectable signal is significant. Also, the field strength would vary over the length of the loop, being strongest at the ends of the coil, and falling by several orders of magnitude at the remote ends of the poles.

The Goldberg '398 patent purports to disclose a magnetic smartcard including a closed magnetic loop in which an inductor element on one leg of the loop generates a modulated field responsive to signals received from a microprocessor. The portion of the closed magnetic loop core that serves to generate the modulated magnetic field for reading by a reader is a combination of ferromagnetic and diamagnetic materials. Bars of ferromagnetic and diamagnetic materials are diagrammatically disclosed to comprise the described combination of materials, and compose this portion of the loop. The flux lines in the loop structure are mostly within the core itself except where forced out by the diamagnetic material. The fact that flux lines are almost entirely within the core in a loop structure mandates the use of some expedient such as the disclosed diamagnetic material. The magnetic inductor element is not positioned in the magnetic strip area where the reader head interfaces with the card. Since efficiency goes down with distance, the '398 patent requires the use of an expedient, the disclosed combined ferromagnetic and diamagnetic material, to facilitate the escape of magnetic flux from the loop so that the flux may impinge on and activate the reader head. There is no suggestion that the use of such a combined material in the reader zone is unnecessary when the coil is placed within this zone. It is not clear that the disclosed '398 device is operable. There is no indication of how the inductor element senses when to generate and when not to generate a magnetic signal, or that such sensing is necessary. If a reader head receives data more than once during the same reading it generates an error, so the inductor element must in some way be limited to sending a magnetic signal to the reader head only once during a reading session. A magnetic strip reader generally needs to sense a reversal of magnetic polarity (that is a flux transition) to generate a signal. A mere modulation in the magnetization of the ferromagnetic strip material would not generate a flux reversal. There is no indication that such a flux reversal is contemplated by the '398 patent.

The Cooper '747 patent purports to disclose a credit card wherein a spatial magnetic pattern is created on an elongated magnetic strip by a plurality of fixed in position coils. Each of the coils generates a separate magnetic field when it is activated. The coils are selectively activated in response to previously stored information to provide a pre-defined magnetic pattern. The positions of the selectively actuated coils determine the magnetic pattern that is presented for reading. The magnetic pattern is static in location so long as the respective magnetic fields that define it continue to be generated. The coils are energized for relatively long periods of time so that current drain is substantial. No reader head sensing elements are disclosed or suggested so there is no choice but to turn on the entire array of electromagnetic elements and leave them on until the card is removed from contact with the reader.

Krause '451 purports to disclose a smart card wherein a transducer is used to temporarily record information in a magnetic pattern on a conventional magnetic stripe. A reader head reads the conventional magnetic stripe rather than directly reading the output from the transducer. The transducer is disclosed to be in the form of wires or coils, each of which can be addressed independently to provide a desired spatial magnetic pattern immediately adjacent to the magnetic stripe. The magnetic pattern is transferred to the conventional magnetic stripe. The magnetic pattern is erased or scrambled from the magnetic stripe after each reading so that the magnetic stripe must be re-imprinted with every usage. This is energy intensive, and exceeds the capacity of currently available thin batteries. The '451 card could at best be used only a few times. This is not practical for the user. In apparent recognition of this problem, the '451 patent discloses the extraction of power from the magnetic card reader. Card readers are not generally equipped to provide power in this way.

These and other difficulties of the prior art have been overcome according to the present invention.

### BRIEF SUMMARY OF THE INVENTION

A preferred embodiment of the transaction card according to the present invention comprises a transaction card in a smartcard format wherein the components of the transaction card and an associated magnetic pattern reader have been constructed and arranged to minimize the consumption of electrical power. A transducer is utilized to generate a spatial, wave, or temporal form of a magnetic pattern, and the pattern is read by means of a magnetic pattern reader. The magnetic permeability of the transducer is reduced, preferably to a small fraction of that of the reader. Readers typically are constructed of materials that exhibit magnetic permeabilities of 10,00 to 40,000 or more, while the core of the transducer can be an air core, which has a magnetic permeability of 1. This tends to force the flux out of the transducer and draw it into the reader. The relative permeabilities are measured at the same frequency, and at the magnetic saturations that exist in use as described herein. The reader has much more mass so it is typically much less saturated than the small transducer in the transaction card. The generation of wave or temporal forms of magnetic patterns are particularly modest in their power requirements. Various means can be employed to level the flux density across the transducer, including, for example, asymmetrical positioning of mass in the transducer, and the use of materials with anisotropic flux emitting properties in flux controlling association with the transducer.

Other objects, advantages, and novel features of the present invention will become apparent from the following detailed description of the invention when considered in conjunction with the accompanying drawings.

### BRIEF DESCRIPTION OF THE DRAWINGS

The present invention provides its benefits across a broad spectrum of transaction cards. While the description which follows hereinafter is meant to be representative of a number of such applications, it is not exhaustive. As those skilled in the art will recognize, the basic methods and apparatus taught herein can be readily adapted to many uses. It is applicant's intent that this specification and the claims appended hereto be accorded a breadth in keeping with the scope and spirit of the invention being disclosed despite what might appear to be limiting language imposed by the requirements of referring to the specific examples disclosed.

Referring particularly to the drawings for the purposes of illustration only and not limitation:

FIG. 1 is a schematic plan view of a preferred embodiment of a transaction card in a smartcard format according to the present invention.

FIG. 2 is a schematic cross-sectional view of a coil based magnetic transducer in a transaction card readably associated with a magnetic pattern reader.

FIG. 3 is a representation of the relationship between magnetic flux and an electrical current flowing in an electrical conductor.

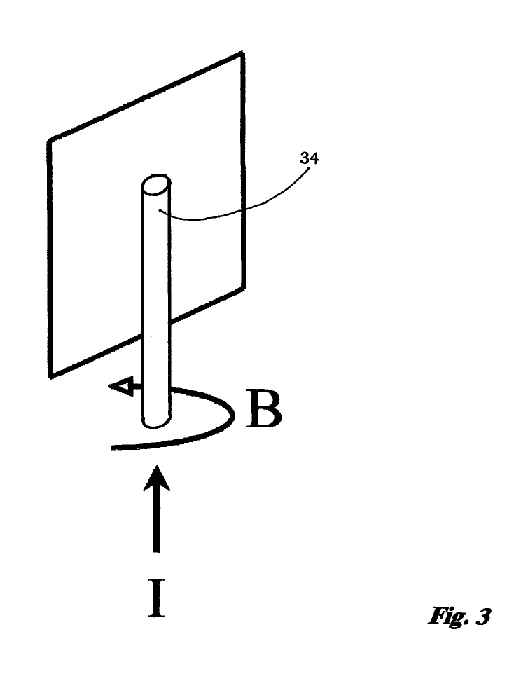

FIG. 4 is a schematic plan view of a magnetic transducer formed by a single wire laid down on a substrate in a series of patterned loops with the magnetic polarity as indicated.

FIG. 5 is a schematic plan view of a magnetic transducer formed by an array of independently actuatable wires laid down on a substrate in a uniform pattern with the polarity as shown. It should be noted that in FIGS. 4 and 5 the arrows identified with the letter “E” indicate the direction of electron flow. Current flows in the opposite direction.

### DETAILED DESCRIPTION OF THE PREFERRED EMBODIMENTS

Referring now to the drawings wherein like reference numerals designate identical or corresponding parts throughout the several views, there is illustrated generally at 10 a transaction card such as a financial, identification, key, personal information, or the like transaction card. This transaction card is in a smartcard format with a plurality of operatively connected members embedded within the card.

A magnetic reading zone 12 indicates where a magnetic pattern generating transducer 18 is located within the structure of transaction card 10. Magnetic reader zone 12 is also described as a swipe zone. This has reference to the fact that transaction cards are typically swiped through a reader.

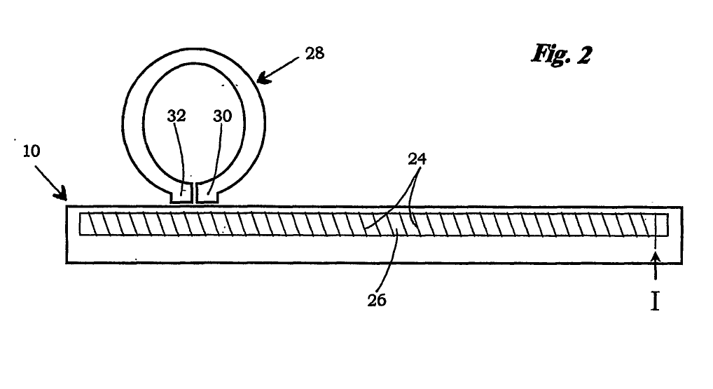

The electronic components of the transaction card 10 are supplied with electrical power by energy source 14. Energy source 14 provides all of the power required to operate the transaction card 10 while it is being read by a magnetic pattern reader such as that shown, for example, at 28 in FIG. 2. No external power is required for the operation of the transaction card 10. The energy source 14 can be replenished from an external power source (not shown) if desired. Alternatively, the energy source 14 can be replaced from time to time.

A sensor array composed, for example, of sensor members 20 and 22 is located generally within the magnetic reader zone 12 at opposite ends of transducer 18. The sensor members 20 and 22 in the sensor array sense the presence of a magnetic pattern reader such as that shown, for example, at 28 in FIG. 2. This sensed information is transmitted to logic processor 16 where it is processed and action taken according to pre-existing instructions found in logic processor 16. Transaction card 10 may be swiped past a reader from either direction so it is desirable to provide for sensing the presence of a reader head at either end of elongated transducer member 18. The reader head signals its presence, inter alia, by the point pressure that it exerts on a portion of the reader zone 12. The leading sensor, that is, the sensor that is alerted first by the reader head, serves to activate the system. The trailing sensor serves to deactivate the system.

There is no intelligible or useful detectable magnetic pattern in the magnetic reading zone 12 until the sensor array senses that a magnetic pattern reader is approaching or in the zone. The alerted sensor signals the logic processor, and the processor causes a predetermined magnetic pattern to be generated by magnetic transducer 18. This pattern can be generated in several different forms.

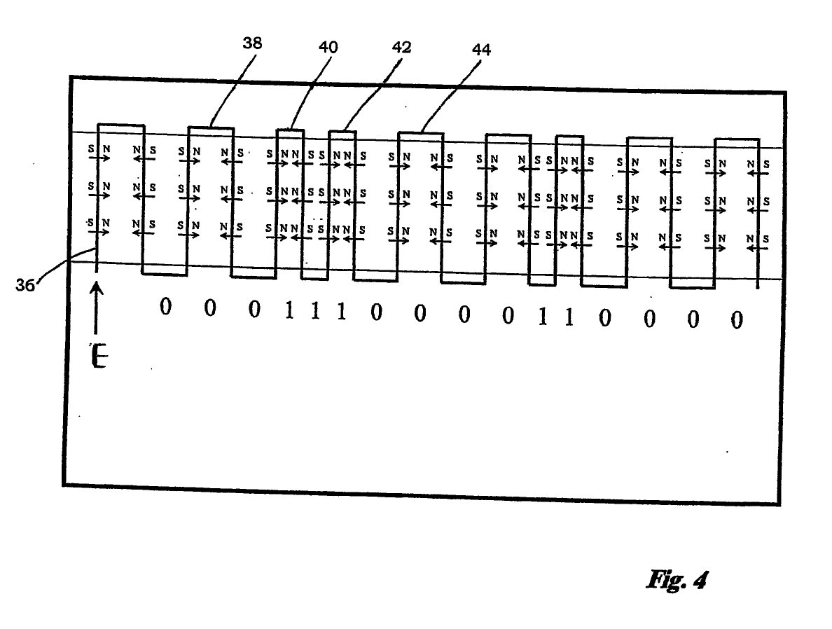

If the transducer is in the form of a single wire 36, as shown, for example, in FIG. 4, the digital magnetic pattern of magnetic flux reversals can be encoded representing digital “1s” and “0s” will be generated according to the fixed physical pattern of the wire. The spacing between the legs of the loops 38, 40, 42, 44, and the like, determine what the generated digital magnetic pattern will be. The pattern is read by a magnetic pattern reader such as 28 by moving or swiping the reader relative to the transducer. In this instance, since there is only one wire 36, the magnetic pattern is displayed continuously by the transducer from the time the reader head passes, for example, sensor 20 until it passes sensor 22. The reading of this spatial form of the magnetic pattern consumes more power than necessary. Further, the pattern generated and the information that it represents is invariant.

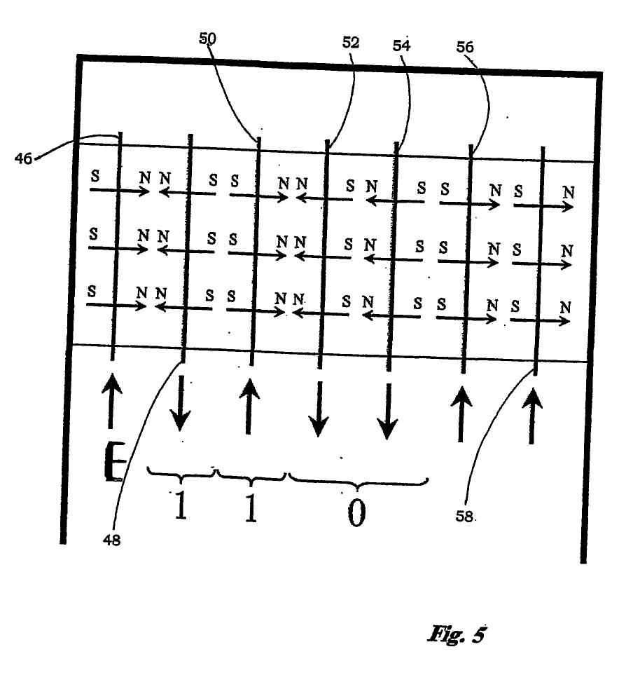

Alternatively, if an array of independently actuatable current carrying members such as 46, 50, 52, 54, 56 and 58 (FIG. 5) is employed as a transducer, the logic processor can control the application of current to selected ones of the current carrying members so as to generate any desired magnetic pattern. Additionally, the pattern can be varied from use to use. Since the reader head signals its presence, for example, by a drop in magnetic impedance when it passes by an area, this signal generated in the electromagnetic circuit in the card, from the reader can be used by the logic processor to determine when to turn on only the current carrying members that are about to be passed by the reader, and to turn off the current carriers that the reader head has already passed. The power drain on the energy source 14 is thus significantly reduced. The magnetic pattern appears the same to the reader head as did the pattern generated by the embodiment of FIG. 4. In reality, the magnetic pattern, although it is spatial in nature, moves in a wave with the reader along the transducer, and the only piece of it that exists at a given point in time is that which is in proximity to the reader. The power savings are significant.

According to a further embodiment, an electromagnetic member such as the coil transducer shown schematically in FIG. 2 can be employed. The electromagnetic member of FIG. 2 is comprised of a continuously spiral wound electrical current conductor, adjacent wraps of which are illustrated at 24. Wraps 24 are arrayed or wound on elongated core 26. Because of their thicknesses, transaction cards employ flattened coils that are sometimes applied by lithographic or other techniques that do not require actually winding a wire around a core. Elongated core 26 can be a metal, thermoplastic material or even air, If desired. The magnetic pattern reader or head 28 is in the general form of a horseshoe electromagnet with the poles indicated at 30 and 32, respectively. For ease of illustration, the coils on the magnet are not shown. Reading of the magnetic pattern is accomplished by passing reader 28 immediately adjacent to the pattern generating components of the transducer. Generally, the closer the reader is positioned to the elements that generate the magnetic pattern or signal, the lower the power drain. The logic processor causes, for example, a series of pulses of electrical current to be transmitted to the coil to generate a predetermined temporal magnetic pattern across the entire length of the electromagnetic transducer. The polarity is reversed with each pulse so that a pattern of magnetic reversals is generated. The pulses follow one another sequentially. Each pulse appears substantially instantaneously at all points along the transducer. The entire magnetic pattern appears pulse by pulse at each point along the transducer, spaced in time but not distance, so this temporal magnetic pattern could be read by a stationary reader at any point along the transducer. The magnetic domains are not separated spatially. Transmittal of this temporal form of the entire magnetic pattern preferably takes less than 100 milliseconds, and preferably less than 50 milliseconds. At this rate, the transaction card 10 is likely to remain in readable association with the head 28 long enough to receive the entire magnetic pattern pulse by pulse, no matter how fast the card is swiped through the reader. The individual pulses are so short in duration that the reader sees them as though the reader and transducer were stationary relative to one another, even though the head may move relative to the magnetic pattern generator between pulses. It does not matter that the rate of movement of the reader relative to the magnetic pattern generator is not constant. This is an advantage as against the typical magnetic strip card, which must be swiped through the reader at a constant rate. So long as the reader 28 is adjacent to the magnetic pattern generator at some location to receive each pulse, the relative spatial locations are not significant. This magnetic pattern is temporal in nature in that it is not fixed in space, and is the same at all locations along the transducer at essentially the same point in time. As previously noted, the pattern is only transmitted once. If the reader 28 sees the same number more than once it will generally generate a read error.

With all of these wave forms little or no energy is expended to turn the magnetic pattern off once it is read, and nothing is left to be read by an unauthorized user.

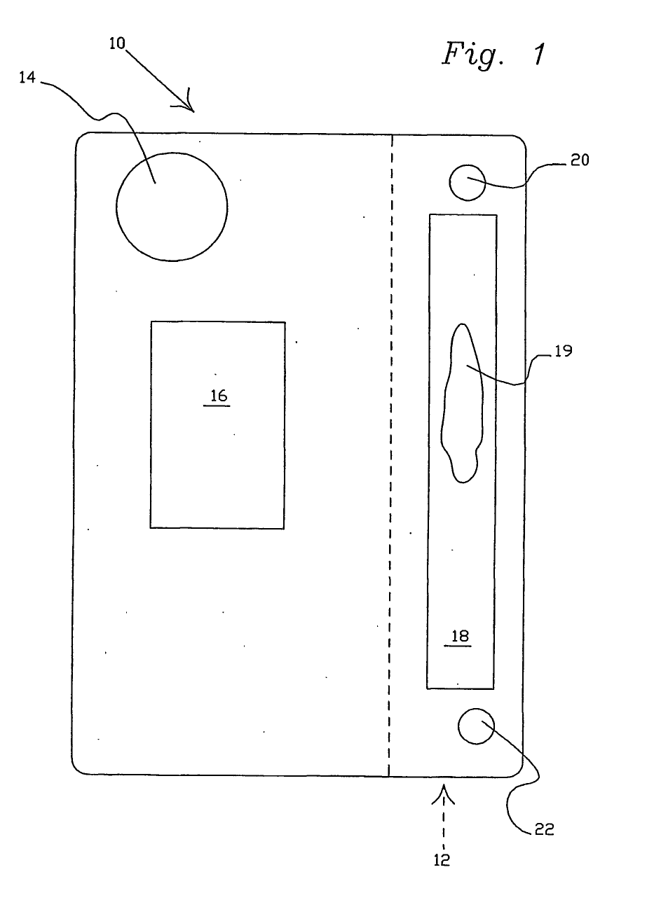

The reader 28 does not generally accommodate large fluctuations in flux density very well. If it receives one part of a magnetic pattern while it is in a region of high flux density and another part of the pattern in an area of low flux density, it may generate an error. It is inherent in most linear electromagnets that the flux density will be greater at the ends of the generator. It is possible to selectively control the flux density along the length of a pattern generator so as to more or less equalize the flux density to the extent that the reader will not generate an error. The grain orientation or other crystal structure of a core or overlying material can be altered in certain areas so as to render those areas magnetically anisotropic. It is well known that altering the grain or other material characteristics of a sheet of ferromagnetic material can cause the flux to preferentially exit one set of faces of the sheet. Also, providing more mass of material in one location can alters the flux density in that area. Material can be added that has a different magnetic permeability or is even diamagnetic as compared to adjacent areas. Many of these flux adjustments can be accomplished by the use of a stripe of material, which superficially resembles a conventional magnetic stripe, between the transducer and the reader. This material is chosen so that it exhibits very low coercivity. Thus, it does not retain the magnetic pattern that is transmitted through it. It serves only to enhance or change the magnetic field strength as it passes directly from the transducer to the reader through the material. It is incapable of holding and re-transmitting the magnetic pattern once the electromagnetic transducer is turned off. If an anisotropic material is provided and oriented to present the face through which the flux preferentially exits to the reader, the apparent flux density will be enhanced. The selective adjustment of the flux density by these and other means is symbolically represented by 19 in FIG. 1.

The magnetic reading zone 12 and associated transducer are positioned so that the transaction cards of the present invention will remain compatible with the existing infrastructure of magnetic stripe readers. These existing readers will still be able to read transaction cards constructed according to the present invention.

The transducers can take various forms. Those illustrated are intended to be exemplary but not exhaustive of the possible transducers that are suitable for use according to the present invention. For example, loop electromagnetic members are well known in the art. See, for example, Goldberg '398, discussed above. In order to conserve power the electromagnetic element (the magnetic generator) that produces the magnetic pattern should be as close to the reader as possible so that the magnetic pattern is transmitted directly from the generator to the head of the reader. This transmission is considered to be direct despite intervening flux adjusters or protective overlays. To this end, at least part, and preferably all, of the magnetic generator should be positioned within the magnetic reading zone. Portions of the transducer, such as loops and connectors, can extend outside of the magnetic reading zone, so long as the electromagnetic element that generates the magnetic pattern is positioned closely adjacent to the reader. Typically, a transaction card can include several electromagnetic elements corresponding to the several tracks that are found in conventional magnetic stripes.

The term “logic processor” broadly includes all of the processing components that are required to control the operation of the system as described herein. Such components, their assembly and use are well known in the art, and will not be described in detail here. The components are logically connected to the logic processor, and electrically connected to the energy source. Various materials and techniques for making printed circuit boards are well known and will not be repeated here.

The energy source can be any source of electrical current. Fixed and removable primary and secondary batteries are contemplated, as are solar cells, tritium based cells, and the like. For ease of use, it is necessary that the energy source function without external energy input for at least 50, and preferably 500 or more uses before energy replenishment is necessary. Where a transaction card is only used once a week, for example, to open a seldom opened door, a low number of uses between charging cycles would not be a serious drawback. A day of shopping with a typical credit card can easily require more than 20 unaided uses. A transaction card that requires frequent recharging would be unattractive to many users. The minimization of power consumption is essential to the use of smartcard form transaction cards.

A significant feature of the present invention is the proportioning of the magnetic permeability between the magnetic head of the magnetic pattern reader and the electromagnetic element that generates the magnetic pattern. When the magnetic permeability of the magnetic pattern reader is significantly higher than that of the electromagnetic element, the head draws the magnetic flux that makes up the pattern out of the transaction card. Flux levels that are too low to read by an order of magnitude or so can be read by substantially lowering the magnetic permeability of the electromagnetic element. This is counterintuitive because lowering the magnetic permeability of the electromagnetic generator reduces the flux output. The use of an air core with a magnetic permeability of one as against a magnetic pattern reader with a magnetic permeability of 10,000 or more allows very faint magnetic patterns to be read. The magnetic permeability of the reader should be at least one and one half times, and preferably at least two times, and more preferably at least five times or more that of the magnetic pattern generator. Significantly less power is used in generating faint magnetic patterns, thus substantially prolonging the life of the energy source. Also, low permeability cores require less energy to saturate as compared with high permeability cores.

What have been described are preferred embodiments in which modifications and changes may be made without departing from the spirit and scope of the accompanying claims. Clearly, many modifications and variations of the present invention are possible in light of the above teachings. It is therefore to be understood that, within the scope of the appended claims, the invention may be practiced otherwise than as specifically described.

What is claimed is:

1. A transaction card including a magnetic reading zone extending generally linearly along said transaction card, said transaction card including operatively interconnected members comprising:
at least one transducer member, said transducer member including an electromagnetic element, said electromagnetic element extending in said magnetic reading zone;
a sensor member, said sensor member being adapted to sensing the presence of a magnetic pattern reader in said magnetic reading zone;
a logic processor member adapted to control said members;
an energy source self contained within said transaction card and adapted to supply electrical power to said members; and
said electromagnetic element being adapted to generating a magnetic pattern responsive to information received from said logic processor member at a time indicated by said sensor member and when said magnetic pattern reader is readably positioned in said magnetic reading zone, said magnetic pattern being generated so that the magnetic pattern moves generally linearly in said magnetic reading zone relative to said electromagnetic element and is adapted to being read directly by said magnetic pattern reader.

2. A transaction card according to claim 1 wherein said electromagnetic element comprises an electrically conductive coil.

3. A transaction card according to claim 1 wherein said transducer is in the form of a magnetic loop.

4. A transaction card according to claim 1 wherein said transducer is linear.

5. A transaction card according to claim 1 wherein said electromagnetic element includes a core element having a first magnetic permeability, and said electromagnetic element is adapted to be readably associated with a said magnetic pattern reader having a magnetically permeable reader head, said reader head having a second magnetic permeability, said second magnetic permeability being at least approximately one and one half times said first magnetic permeability.

6. A transaction card according to claim 1 wherein said electromagnetic element is adapted to generating said magnetic pattern only once when said magnetic pattern reader is readably positioned in said magnetic reading zone,

7. A process of extracting magnetically encoded information from a transaction card, said process comprising:
selecting said transaction card comprising a plurality of operatively interconnected members including at least one electromagnetic member, said electromagnetic member including a first core element and being adapted to generating a magnetic pattern, said first core element having a first magnetic permeability, a logic processor member adapted to controlling the generation of said magnetic pattern, a self contained energy source adapted to powering said members;
selecting a magnetic pattern reader device, said magnetic pattern reader device including a magnetically permeable second core element, said magnetically permeable second core element having a second magnetic permeability, said second magnetic permeability being at least approximately one and one half times said first magnetic permeability; and
readably associating said magnetic pattern reader device with said first core element, generating said magnetic pattern, and allowing said magnetic pattern reader device to directly read said magnetic pattern.

8. A process of claim 7 including generating a said magnetic pattern that is temporal.

9. A process of claim 7 including generating a said magnetic pattern that is spatial.

10. A process of claim 7 including selecting a transaction card including a plurality of electromagnetic members.

11. A process of claim 7 including generating a said magnetic pattern only once while said magnetic pattern reader device is readably associated with said first core element.

12. A process of claim 7 including selecting said transaction card comprising a sensor member, said sensor member being adapted to sense when said magnetic pattern reader device is readably associated with said first core element, and generating said magnetic pattern only once while said magnetic pattern reader device is readably associated with said first core element.

13. A process of claim 7 including selecting said transaction card comprising a sensor array, said sensor member being included in said sensor array, said sensor array being adapted to sense when said magnetic pattern reader device becomes readably associated with said first core element and when said magnetic pattern reader device is not so readably associated.

14. A process of claim 7 wherein said generating includes generating a plurality of magnetic polar reversals in a temporal pattern.

15. A process of claim 7 including moving said transaction card and said magnetic pattern reader device relative to one another while said magnetic pattern reader device is readably associated with said first core element, and generating a said magnetic pattern that moves in a wave with said magnetic pattern reader device.

16. A combination comprising a transaction card and a magnetic pattern reader device:
said transaction card comprising a plurality of operatively interconnected members including at least one electromagnetic member, said electromagnetic member including an elongated first core element and being adapted to generating a magnetic pattern, said elongated first core element having a first magnetic permeability, a logic processor member adapted to controlling the generation of said magnetic pattern, a self contained energy source adapted to powering said members;
said magnetic pattern reader device including a magnetically permeable second core element, said magnetically permeable second core element having a second magnetic permeability, said second magnetic permeability being greater than said first magnetic permeability, said magnetic pattern reader device adapted to being readably associated with said elongated first core element, and adapted to directly reading said magnetic pattern while so readably associated.

17. A combination of claim 16 wherein said second magnetic permeability is at least approximately twice said first magnetic permeability.

18. A combination of claim 16 wherein said second magnetic permeability is at least approximately one and one half times said first magnetic permeability.

19. A combination comprising a transaction card and a magnetic pattern reader device:
said transaction card comprising a plurality of operatively interconnected members including at least one electromagnetic member, said electromagnetic member including an elongated first core element and being adapted to generating a magnetic pattern, said elongated first core element having a first magnetic permeability, a logic processor member for controlling the generation of said magnetic pattern, a self contained energy source for powering said members;
said magnetic pattern reader device including a magnetically permeable second core element, said magnetically permeable second core element having a second magnetic permeability, said second magnetic permeability being at least approximately one and one half times said first magnetically permeability, said magnetic pattern reader device adapted to being readably associated with said elongated first core element and to directly reading said magnetic pattern while so readably associated.

20. A combination of claim 19 wherein said second magnetic permeability is at least approximately five times said first magnetic permeability.
